(19) United States
(12) Patent Application Publication
(10) Pub. No.: US 2009/0192634 A1
(43) Pub. Date: Jul. 30, 2009

(54) DIGITAL PID CONTROLLER

(75) Inventor: Hiroshi FUJINAKA, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/348,343

(22) Filed: Jan. 5, 2009

(30) Foreign Application Priority Data
Jan. 29, 2008 (JP) 2008-018351

(51) Int. Cl. G05B 13/02

(52) U.S. Cl. 700/42; 700/54

(57) ABSTRACT

A digital PID controller controlling a control subject to be in a target state includes: a detector detecting analog data of a current state of the control subject; an AD converter converting the analog data to a digital value; and a digital PID control unit (i) receiving an error value and (ii) digitally performing at least one of integral calculation and derivative calculation to generate a manipulated variable. The digital PID control unit includes at least one of: a first suppression unit suppressing the error value when an absolute value of the error value is equal to or smaller than a first set value; and a second suppression unit suppressing the error value when the absolute value is equal to or smaller than a second set value, and performs the integral calculation and the derivative calculation on the outputs of the first suppression unit and the second suppression unit, respectively.

### BACKGROUND OF THE INVENTION

(1) Field of the Invention

The present invention relates to proportional-integral-derivative (PID) controllers, and more particularly to a technology of controlling a control subject to be driven with low noise and low vibration.

(2) Description of the Related Art

Conventionally, PID controllers have been used in various position controls. In recent years, the applications of the PID controllers include positioning of industrial robotic arms and lens position control in image stabilization of Digital Still Cameras (DSCs), well-known as digital cameras. A control method used in the PID controllers is the common PID control algorithm. By the method, proportional, integral, and/or derivative calculations are performed on an error that is a difference between a feedback value and a target value of a subject to be controlled, thereby generating a manipulated variable. Then, the subject is driven according to the generated manipulated variable. An example of the common PID controllers is disclosed in Patent Reference 1 (Japanese Unexamined Patent Application Publication No. 64-26202), for example. The following describes this conventional PID controller disclosed in Patent Reference 1 with reference to FIG. 8.

FIG. 8 is a block diagram of a conventional PID control system including the conventional PID controller disclosed in the Patent Reference 1. Here, only basic elements necessary to explain the principles of the conventional PID control system are described. The conventional PID control system of FIG. 8 includes a control subject 301 and the conventional PID controller. The conventional PID controller includes a detector 302, a subtracter 303, a PID control unit 309, and a drive unit 310. The PID control unit 309 includes a proportional calculation unit 304, an integral calculation unit 305, a derivative calculation unit 306, an adder 307, and a gain multiplication unit 308.

Hereinafter, the expression “control subject” means a subject to be controlled by a corresponding digital PID controller. Examples of the control subject 301 are a robotic arm, a lens of a DSC, and the like. The detector 302 such as a hole sensor determines a current position of the control subject 301. Then, the subtracter 303 calculates a difference between the determined current position and a target value of the control subject 301, and then provides the calculated difference as an error value to the PID control unit 309. When the PID control unit 309 receives the error value from the subtracter 303, each of the proportional calculation unit 304, the integral calculation unit 305, and/or the derivative calculation unit 306 in the PID control unit 309 performs calculation on the error value using a corresponding control time constant. A result of the calculations is provided as a manipulated variable to the drive unit 310. The drive unit 310 drives the control subject 301 according to the received manipulated variable.

The above-described processing controls the control subject 301 to eventually have the target value. The control characteristics of the processing are generally expressed by the following equation (1), where Kp is a proportional gain of the gain multiplication unit 308, TI is an integral time of the integral calculation unit 305, TD is a derivative time of the derivative calculation unit 306, η is a derivative coefficient of inexact differential, E(s) is an error, and MV(s) is a manipulated variable.

MV(s)=Kp×{1+1/(TI×s)+(TD×s)/(1+η×TD×s)}×E(s) (Equation 1)

In Patent Reference 1, in order to reduce overshooting of the control subject 301, the integral calculation unit 305 performs the integral calculation after an error value equal to or more than a predetermined value is calculated to be zero. On the other hand, Patent Reference 2 (Japanese Unexamined Patent Application Publication No. 61-190602) discloses another method for reducing overshooting of a control subject due to a rapid change in a target value. In order to reduce the overshooting, a controller disclosed in Patent Reference 2 has a delay unit in a path of receiving a target value or at a stage preceding the integral calculation unit 305. As described above, the conventional PID controllers attempt to dynamically improve control performance.

When the above-described PID control method is executed by an analog circuit, there are various drawbacks of difficulties in circuit change, accuracy management, and compact implementation, and also a drawback of general impossibility of nonlinear control. Therefore, when commercial-off-the-shelf devices and the like use the PID control method, the method is generally performed digitally by digital PID controllers using computer control.

However, such conventional digital PID controllers have problems. Even if input target values are constant and not varied, the digital control of the digital PID controllers causes vibration or noise thereby reducing accuracy of the control of the digital PID controllers. In order to explain advantages of the present invention, the following describes a structure of such a conventional digital PID controller with reference to FIG. 9.

FIG. 9 is a block diagram of a conventional digital PID control system including the conventional digital PID controller. As shown in FIG. 9, the conventional digital PID control system includes a control subject 401 and the conventional digital PID controller. The conventional digital PID controller includes a detector 402, a subtracter 403, a PID control unit 409, a drive unit 410, and an analog-to-digital (AD) converter 411. The PID control unit 409 includes a proportional calculation unit 404, an integral calculation unit 405, a derivative calculation unit 406, an adder 407, and a gain multiplication unit 408. In FIG. 9, a current position of the control subject 401 is determined by the detector 402, and then converted into a quantized digital value by the AD converter 411. The subtracter 403 and the PID control unit 409 perform digital calculations on the digital value of the current position, thereby generating a digital manipulated variable. The drive unit 410 performs pulse drive represented by Pulse Width Modulation (PWM), based on the quantized digital manipulated variable itself provided from the PID control unit 409. Or, after the manipulated variable is converted by a digital-to-analog (DA) converter to a quantized analog manipulated variable, the drive unit 410 performs linear drive or pulse drive by using an analog circuit based on the quantized analog manipulated variable.

In such a conventional digital PID controller, even if input target values are constant, an error value calculated by the subtracter 403 is not always perfect zero. In the example of FIG. 9, it is assumed that a target command value (namely, an input target value) is 100.01, and that a value of the current position provided from the AD converter 411 is 100.00. In this situation, an error value calculated by the subtracter 403 is steadily 0.01, not perfect zero. The reasons why the error value cannot be zero are explained as below. Firstly, considered is a situation (1) where a microcomputer or the like that commands the target command value has a higher resolution than a resolution of the AD converter 411, as shown in FIG. 9. In the situation (1), the error value is not always zero because the target command value is not always the same as an output value of the AD converter 411. Next, considered is a situation (2) where some calculation such as filtering is added between the receiving of the target command value to the calculation of the subtracter 403, as disclosed in Patent Reference 2. In the situation (2), the error value is not always zero because quantization inaccuracy or calculation inaccuracy of the calculation such as filtering produces inaccuracy of an error value. For example, even if the target command value is 100.00, an output of the calculation such as filtering is 100.01. Next, considered is a situation (3) where some calculation such as filtering is added between the process of the AD converter 411 and the calculation of the subtracter 403. In the situation (3), the error value is not always zero because of the same reason as given to the situation (2). For example, even if the target command value is 100.00, a feedback value to the subtracter 403 is 100.01. Now, considered is a situation (4) where some calculation such as filtering is added between the process of the subtracter 403 and the process of the PID control unit 409. In the situation (4), the error amount is not always zero because of the same reason as given to the situation (2). For example, even if an output of the subtracter is 403 is zero, an input of the PID control unit 409 is 0.01.

As described above, if an error value is not perfect zero in a state where target values are constant and the control proceeds successfully, such a residual error value is repeatedly accumulated by the integral calculation unit 405. As a result, when the accumulated residual error value reaches the lowest resolution value of the drive unit 410, the drive unit 410 drives the control subject 401. Such drive of the drive unit 410 is undesired processing in the control that currently proceeds successfully. Furthermore, the drive processing causes vibration or noises, thereby reducing accuracy of the control. Moreover, since the conventional digital PID controller uses the AD converter 411, there is a rapid change in feedback values of the current position due to the lowest resolution of the AD converter 411. More specifically, even if an exact amount of a change caused by noise or the like is at a low frequency and minute, the change is a rapid and sudden change for an output of the AD converter 411 and an amount of the change easily reaches the lowest resolution of the AD converter 411. The amount of the change is amplified by the derivative calculation unit 406 to be larger, which results in undesired drive processing and eventual generation of vibration or noises, thereby reducing accuracy of the control.

As described above, in the conventional digital PID controllers, the accumulation of non-zero error values by the integral calculation unit 405 and the amplification of an error value caused by an output of the AD converter 411 by the derivative calculation unit 406 cause problems of the vibration/noise generation and eventual reduction in accuracy of the control. However, reduction in vibration and noises is always desired in the controllers. Unfortunately, the desire for control accuracy improvement and noise reduction is quite difficult to be achieved, when the PID control method is performed by commercial-off-the-shelf devices with high accuracy, such as DSCs having image stabilization functions.

In order to address the above drawbacks and problems, an object of the present invention is to provide a digital PID controller with less vibration or less noise in control processing, thereby improving accuracy of control of the digital PID controller.

### SUMMARY OF THE INVENTION

In accordance with an aspect of the present invention for achieving the object, there is provided a digital PID controller that controls a control subject to be in a target state, the digital PID controller including: a detector that detects a current state of the control subject to generate analog data of the current state; an AD converter that converts the analog data to a digital value of the current state; and a digital PID control unit configured to (i) receive an error value that is a difference between the digital value and a digital target value of the target state, and (ii) digitally perform at least one of integral calculation and derivative calculation depending on the error value to generate a digital manipulated variable to be used to control the control subject, wherein the digital PID control unit includes at least one of: a first suppression unit configured to suppress the error value to be outputted when an absolute value of the error value is equal to or smaller than a first set value; and a second suppression unit configured to suppress the error value to be outputted when the absolute value of the error value is equal to or smaller than a second set value, and the digital PID control unit is configured to digitally perform at least one of the integral calculation on the output of the first suppression unit and the derivative calculation on the output of the second suppression unit, in order to generate the digital manipulated variable.

With the above structure, the digital PID control unit performs the integral calculation on a value suppressed from the error value, when an absolute value of the input error value is equal to or smaller than the corresponding set value (in other words, the error value is within a dead-band width, which means that the error value is approximately zero). As a result, the digital PID controller can prevent accumulation of result values of the integral calculation performed on undesired error values of approximately zero, namely, not perfect zero. In addition, the digital PID control unit performs the derivative calculation on a value suppressed from the error value, when the error value is approximately zero. As a result, the digital PID controller can prevent amplification of result values of the derivative calculation performed on error values caused by the AD converter. In addition, since a value suppressed from the error value for the integral calculation and a value suppressed from the error value for the derivative calculation are decided by different suppression units, it is possible to optimize each value suppressed from the error value depending on the corresponding calculation. Thereby, the digital PID controller can suppress at least one of: (i) undesired drive of the control subject when undesired error value of approximately zero is generated by digital control; and (ii) noise or vibration of the control subject due to the undesired drive. As a result, the digital PID controller can improve accuracy of the control.

It is preferable that the digital PID control unit is configured to (i) receive the error value and (ii) digitally perform at least the integral calculation and the derivative calculation depending on the error value to generate the digital manipulated variable, and includes the first suppression unit and the second suppression unit, and wherein the digital PID control unit is configured to digitally perform: the integral calculation on the output of the first suppression unit; and the derivative calculation on the output of the second suppression unit, in order to generate the digital manipulated variable.

With the above structure, the digital PID control unit performs the integral calculation on a value suppressed from the error value and the derivative calculation on a value suppressed from the error value when the error value is approximately zero. Thereby, the digital PID controller can suppress both of: (i) undesired drive of the control subject when undesired error value of approximately zero is generated by digital control; and (ii) noise or vibration of the control subject due to the undesired drive. As a result, the digital PID controller can further improve accuracy of the control.

It is preferable that the first suppression unit is configured to output a value of zero when the absolute value of the error value is equal to or smaller than the first set value, and the second suppression unit is configured to output a value of zero when the absolute value of the error value is equal to or smaller than the second set value.

With the above structure, when an absolute value of the error value is equal to or smaller than the corresponding set value, in other words, which means that the error value is approximately zero, at least one of the integral calculation and the derivative calculation is performed on a value of zero instead of the error value. Thereby, at least one of (i) preventing the integral calculation from accumulating undesired error values of not perfect zero and (ii) preventing the derivative calculation from amplifying error values caused by the AD converter. Thereby, the digital PID controller can prevent undesired drive of the control subject when digital control of the digital PID controller causes undesired error values of approximately zero, and also reduce noise or vibration of the control subject due to undesired error values. As a result, the digital PID controller can improve accuracy of the control.

It is still preferable that the first suppression unit is further configured to output a first integrate suppression value in proportion to a value that is calculated by subtracting the error value with the first set value, when the absolute value of the error value is greater than the first set value and the error value is positive, and output a second integrate suppression value in proportion to a value that is calculated by adding the error value with the first set value, when the absolute value of the error value is greater than the first set value and the error value is negative, the second suppression unit is further configured to output a first derivative suppression value in proportion to a value that is calculated by subtracting the error value with the second set value, when the absolute value of the error value is greater than the second set value and the error value is positive, and output a second derivative suppression value in proportion to a value that is calculated by adding the error value with the second set value, when the absolute value of the error value is greater than the second set value and the error value is negative, and the digital PID control unit is configured to digitally perform at least one of: the integral calculation on the first integral suppression value or the second integral suppression value; and the derivative calculation on the first derivative suppression value or the second derivative suppression value.

With the structure, it is possible to ensure (i) linearity of input-output characteristics of the suppression unit in a region where error values are not zero nor approximately zero, and (ii) continuity of outputs of the suppression unit at a boundary between a region where error values are zero or approximately zero and the region where error values are not zero nor approximately zero. As a result, even if error values are varied astride the boundary (in other words, absolute values of the error values are varied around the corresponding set value, being smaller and greater than the corresponding set value), the digital PID controller can prevent undesired drive for the control subject due to inaccurate integral calculation, and also can reduce vibration or noise due to harmonic of inaccurate derivative calculation. In addition, different set values can be set for the integral calculation and the derivative calculation, respectively. As a result, the digital PID controller can perform the calculations with higher accuracy depending on situations of the control subject.

It is still preferable that the digital PID controller further includes at least one of: an integral selector which selects between the output of the first suppression unit and the error value; and a derivative selector which selects between the output of the second suppression unit and the error value, and the digital PID control unit is further configured to digitally perform at least one of: the integral calculation on one of the output and the error value selected by the integral selector; and the derivative calculation on one of the output and the error value selected by the derivative selector, in order to generate the digital manipulated variable.

With the above structure, the digital PID controller can select the error value or the output of the suppression value to be provided independently for the integral calculation and the derivative calculation.

It is still preferable that the digital PID controller further includes a target value variation determination unit configured to (i) detect a degree of variations in the digital target values, and (ii) perform at least one of: (ii-1) instruction to the integral selector to (ii-1-1) select the output of the first suppression unit when the degree of the variations is small and (ii-1-2) select the error value when the degree of the variations is large; and (ii-2) instruction to the derivative selector to (ii-2-1) select the output of the second suppression unit when the degree of the variations is small and (ii-2-2) select the error value when the degree of the variations is large.

With the above structure, it is possible to select the error value or the output of the suppression value to be provided independently for the integral calculation and the derivative calculation, depending on whether a target state of the control subject is varied (namely, a degree of variations in the target values is small) or constant (namely, a degree of variations in the target values is large). As a result, the digital PID controller can perform the calculations with higher accuracy depending on situations of the control subject.

It is still preferable that the first suppression unit is further configured to output an integrate suppression value in proportion to the error value, when the absolute value of the error value is greater than the first set value, and the second suppression unit is further configured to output a derivative suppression value in proportion to the error value, when the absolute value of the error value is greater than the second set value, and the digital PID control unit is configured to digitally perform at least one of: the integral calculation on the integral suppression value; and the derivative calculation on the derivative suppression value.

With the above structure, in the region where the error values are not zero nor approximately zero, outputs of the integral calculation are not deviated from desired values, in other words, the outputs have no distortion caused by the suppression of the suppression unit. That is, in the integral calculation, an offset between a well-balanced state and a target state of the control subject is suppressed. In addition, different set values can be set for the integral calculation and the derivative calculation, respectively. As a result, the digital PID controller can perform the calculations with higher accuracy depending on a state of the control subject.

It is still preferable that the first suppression unit is further configured to output a first integrate suppression value in proportion to a value that is calculated by subtracting the error value with the first set value, when a degree of variations in the digital target values is small, the absolute value of the error value is greater than the first set value, and the error value is positive, output a second integrate suppression value in proportion to a value that is calculated by adding the error value with the first set value, when the degree of the variations in the digital target values is small, the absolute value of the error value is greater than the first set value, and the error value is negative, output a third integrate suppression value in proportion to the error value, when the degree of the variations in the digital target values is large and the absolute value of the error value is greater than the first set value, the second suppression unit is further configured to output a first derivative suppression value in proportion to a value that is calculated by subtracting the error value with the second set value, when the degree of the variations in the digital target values is small, the absolute value of the error value is greater than the second set value, and the error value is positive, output a second derivative suppression value in proportion to a value that is calculated by adding the error value with the second set value, when the degree of the variations in the digital target values is small, the absolute value of the error value is greater than the second set value, and the error value is negative, and output a third derivative suppression value in proportion to the error value, when the degree of the variations in the digital target values is large, and the absolute value of the error value is greater than the second set value, and the digital PID control unit is configured to digitally perform at least one of: the integral calculation on the first integral suppression value, the second integral suppression value, or the third integral suppression value; and the derivative calculation on the first derivative suppression value, the second derivative suppression value, or the third derivative suppression value.

With the above structure, when the target values are constant (in other words, when a degree of variations in the target values is small, which means that the control subject is to be still), input-output characteristics of the suppression unit are desired to be continuous at the boundary. On the other hand, when the target values are varied (in other words, when a degree of variations in the target values is large, which means that the control subject is to be moved), the input-output characteristics of the suppression unit are desired to match the original non-suppressed input-output characteristics. As a result, it is possible to efficiently prevent undesired drive for the control subject and the previously-mentioned offset, and also possible to efficiently reduce vibration or noise of the control subject. In addition, different set values can be set for the integral calculation and the derivative calculation, respectively. As a result, the digital PID controller can perform the calculations with higher accuracy depending on situations of the control subject.

It is still preferable that the first suppression unit is further configured to output an integrate suppression value in proportion to the error value, when the absolute value of the error value is greater than the first set value, the second suppression unit is further configured to output a first derivative suppression value in proportion to a value that is calculated by subtracting the error value with the second set value, when the absolute value of the error value is greater than the second set value and the error value is positive, and output a second derivative suppression value in proportion to a value that is calculated by adding the error value with the second set value, when the absolute value of the error value is greater than the second set value and the error value is negative, and the digital PID control unit is configured to digitally perform at least one of: the integral calculation on the integral suppression value; and the derivative calculation on the first derivative suppression value or the second derivative suppression value.

With the above structure, in a region where the error values are not zero nor approximately zero, outputs of the integral calculation are not deviated from desired values, in other words, the outputs have no distortion influenced by the suppression of the suppression unit. That is, in the integral calculation, the offset between a well-balanced state and a target state of the control subject is suppressed. Furthermore, it is possible to ensure linearity of the input-output characteristics of the suppression unit in a region where error values are not zero nor approximately zero, and continuity of outputs of the suppression unit at a boundary between a region where error values are zero or approximately zero and the region where error values are not zero nor approximately zero. As a result, even if error values are varied astride the boundary (in other words, absolute values of the error values are varied around the corresponding set value, being smaller and greater than the corresponding set value), the digital PID controller can reduce vibration or noise due to harmonic of inaccurate derivative calculation. In addition, different set values can be set for the integral calculation and the derivative calculation, respectively. As a result, the digital PID controller can perform the calculations with higher accuracy depending on situations of the control subject.

It is still preferable that the digital PID controller further includes a set value adjustment unit configured to adjust at least one of the first set value and the second set value, according to a degree of variations in the digital target values or the error value.

With the above structure, it is possible to adjust the dead-band width ranging from a negative value of the corresponding set value to a positive value of the corresponding set value, depending on whether the target state of the control subject is varied or constant (namely, depending on a degree of variations in the target values), or depending on a size of the error value. As a result, the digital PID controller can perform the integral and derivative calculations with high accuracy depending on situations of the control subject or situations of the control.

It should be noted that the present invention can be implemented not only as the digital PID controller including the above characteristic units, but also as: a digital PID controller including the above characteristic units and an actuator (in other words, a drive unit) that drives the control subject, in order to produce the same advantages.

It should also be noted that the present invention can be implemented not only as the digital PID controller including the above characteristic units, but also as: a digital PID control method including steps performed by the characteristic units of the digital PID controller.

Accordingly, in the digital PID controller of the present invention, when a calculated error value is approximately zero, (i) a value suppressed from the error value or (ii) a value of zero is generated to be provided to at least one of integral calculation and derivative calculation. Thereby, the digital PID controller of the present invention can prevent at least one of: accumulation of undesired error value that is not perfect zero in the integral calculation; amplification of an error value caused by an output of the AD converter in the derivative calculation.

### FURTHER INFORMATION ABOUT TECHNICAL BACKGROUND TO THIS APPLICATION

The disclosure of Japanese Patent Application No. 2008-018351 filed on Jan. 29, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing an example of a configuration of a digital PID control system including a digital PID controller according to a first embodiment of the present invention;

FIG. 2A is a graph of first dead-band characteristics of a dead-band unit included in the digital PID controller according to the present invention;

FIG. 2B is a graph of second dead-band characteristics of the dead-band unit included in the digital PID controller according to the present invention;

FIG. 2C is a graph of temporal changes in input and output of the dead-band unit having the first dead-band characteristics according to the present invention;

FIG. 2D is a graph of temporal changes in input and output of the dead-band unit having the second dead-band characteristics according to the present invention;

FIG. 3A is a graph of third dead-band characteristics of the dead-band unit included in the digital PID controller according to the present invention;

FIG. 3B is a graph of fourth dead-band characteristics of the dead-band unit included in the digital PID controller according to the present invention;

FIG. 3C is a graph of fifth dead-band characteristics of the dead-band unit included in the digital PID controller according to the present invention;

FIG. 4 is a block diagram showing an example of a configuration of a digital PID control system including a digital PID controller according to a modification of the first embodiment of the present invention;

FIG. 5 is a block diagram showing an example of a configuration of a digital PID control system including a digital PID controller according to a second embodiment of the present invention;

FIG. 6 is a block diagram showing an example of a configuration of a digital PID control system including a digital PID controller according to a third embodiment of the present invention;

FIG. 7 is a functional block diagram of a DSC in which the digital PID controller according to a fourth embodiment of the present invention is embedded;

FIG. 8 is a block diagram of the conventional PID control system including the conventional PID controller disclosed in Patent Reference 1; and

FIG. 9 is a block diagram of the conventional digital PID control system including the conventional digital PID controller.

### DESCRIPTION OF THE PREFERRED EMBODIMENT(S)

### First Embodiment

A digital PID controller according to the first embodiment includes a digital PID controller that receives, as an input, an error value that is a difference between a digital target value of a target state of a control subject and a digital value which is regarding a current state of the control subject and provided from an AD converter, and that generate a digital manipulated variable to be used for the control subject. The digital PID control unit includes: a first suppression unit that suppresses the error value to be outputted when an absolute value of the error value is equal to or smaller than a first set value; and a second suppression unit that suppresses the error value to be outputted when the absolute value of the error value is equal to or smaller than a second set value. The digital PID control unit digitally performs integral calculation on the output of said first suppression unit and derivative calculation on the output of said second suppression unit, in order to generate the digital manipulated variable. With the above structure, when an absolute value of the input error value is equal to or smaller than the corresponding set value (in other words, the error value is within a dead-band width, which means that the error value is approximately zero), the integral calculation and the derivative calculation are provided with different values that are independently suppressed from the error value, respectively. Thereby, the digital PID controller can achieve at least one of: (i) prevention of accumulation of result values of the integral calculation performed on undesired error values; and (ii) suppression of amplification of result values of the derivative calculation performed on error values caused by the AD converter. As a result, the digital PID controller can prevent undesired drive of the control subject caused by undesired error values, and also reduce noise or vibration of the control subject due to the undesired error values

The following describes the digital PID controller according to the first embodiment of the present invention in more detail with reference to the drawings.

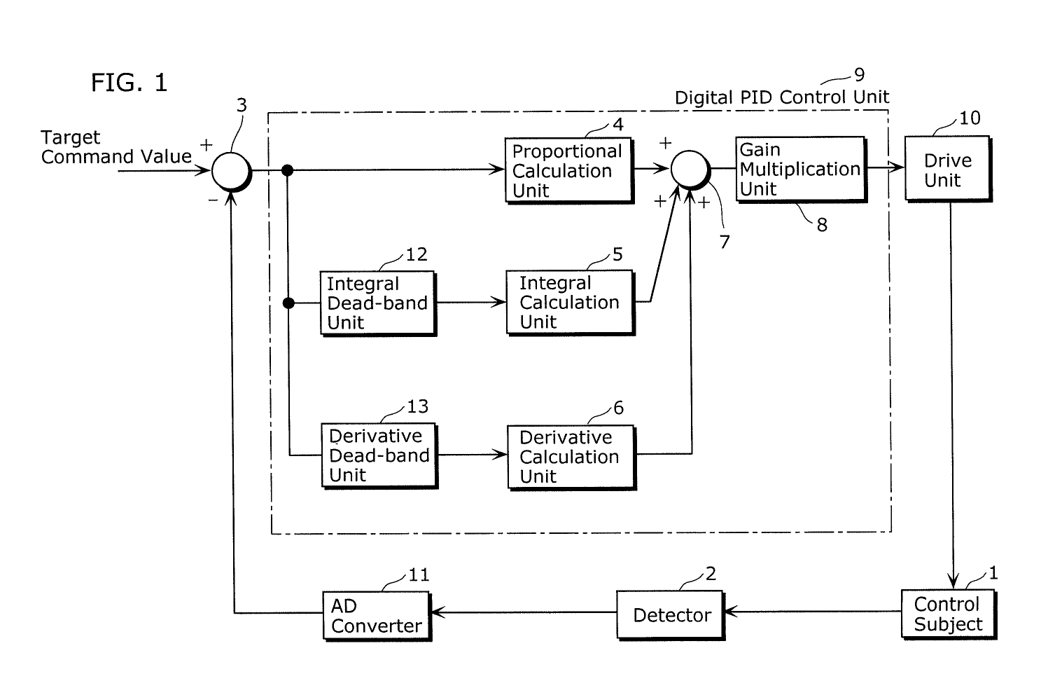

FIG. 1 is a block diagram showing an example of a configuration of a digital PID control system including the digital PID controller according to the first embodiment of the present invention. The digital PID control system of FIG. 1 includes a control subject 1 and the digital PID controller according to the first embodiment. The digital PID controller controls the control subject 1 to have a target command value (hereinafter, referred to also as a “target value” or a “digital target value”), in other words, to be in a target state. Here, the target command value is a digital value of the target state of the control subject 1. The digital PID controller includes a detector 2, a subtracter 3, a digital PID control unit 9, a drive unit 10, and an AD converter 11.

The detector 2 detects a current state of the control subject 1 to generate analog data of the current state. In this example of FIG. 1, the detector 2 determines a current position of the control subject 1 as analog data.

The AD converter 11 converts the analog data to a digital value of the current state of the control subject 1. In this example of FIG. 1, the AD converter 11 converts the analog data of the current position to a quantized digital value.

The subtracter 3 calculates a difference between the digital value and a target command value set for the control subject 1. The calculated difference is provided as an error value to the digital PID control unit 9.

The digital PID control unit 9 includes a proportional calculation unit 4, an integral calculation unit 5, a derivative calculation unit 6, an adder 7, a gain multiplication unit 8, an integral dead-band unit 12, and a derivative dead-band unit 13.

The proportional calculation unit 4 digitally executes proportional calculation on the error value provided from the subtracter 3, thereby generating a digital value in proportion to the error value.

The integral calculation unit 5 digitally executes integral calculation on an output of the integral dead-band unit 12, thereby generating a digital value in proportion to an integral of the output of the integral dead-band unit 12.

The derivative dead-band unit 6 digitally executes derivative calculation on an output of the derivative dead-band unit 13, thereby generating a digital value in proportion to a derivative of the output of the derivative dead-band unit 13.

The integral dead-band unit 12 serves as a first suppression unit that suppresses the error value, in other words, sets the error value to a value of zero or approximates the error value to a value of zero. In more detail, when an absolute value of the error value calculated by the subtracter 3 is equal to or smaller than a first set value, the integral dead-band unit 12 provides the integral calculation unit 5 with a value of zero instead of the error value.

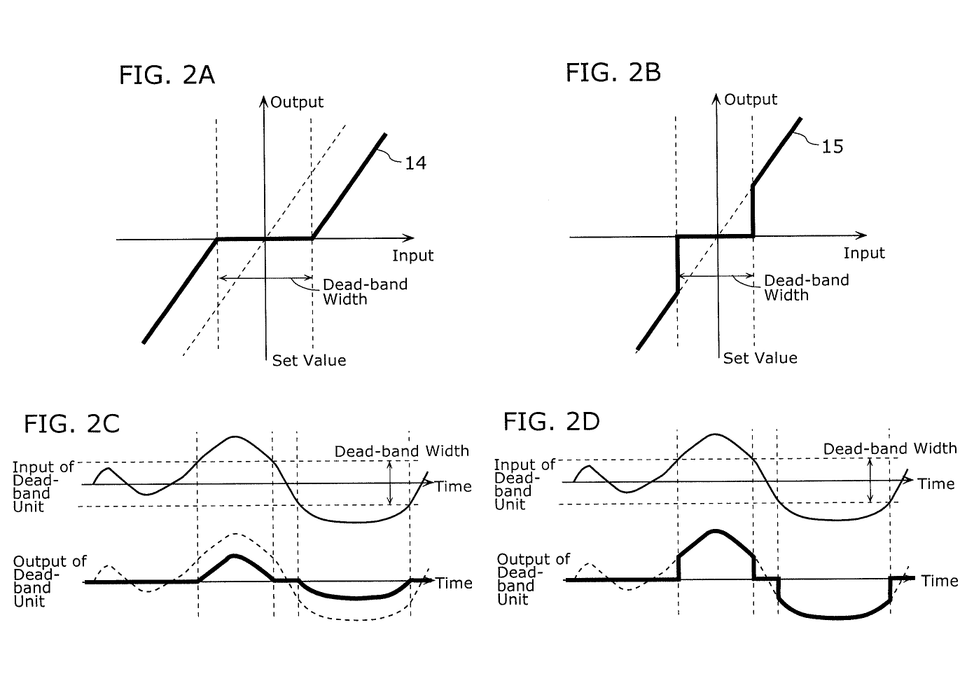

The derivative dead-band unit 13 serves as a second suppression unit that suppresses the error value, in other words, sets the error value to a value of zero or approximates the error value to a value of zero. When an absolute value of the error value calculated by the subtracter 3 is equal to or smaller than a second set value, the derivative dead-band unit 13 provides the derivative calculation unit 6 with a value of zero instead of the error value. Outputs of the integral dead-band unit 12 and the derivative dead-band unit 13 when the absolute value of the error value is greater than the corresponding set value are described later with reference to FIGS. 2A to 2D.

The adder 7 sums the digital values provided from the proportional calculation unit 4, the integral calculation unit 5, and the derivative calculation unit 6.

The gain multiplication unit 8 adjusts the sum provided from the adder 7. More specifically, the gain multiplication unit 8 multiplies the sum by a gain, thereby generating an optimum digital manipulated variable (hereinafter, referred to also simply as a “manipulated valuable”).

The drive unit 10 (in other words, an actuator) drives the control subject 1 according to the digital manipulated variable provided from the gain multiplication unit 8. In more detail, the drive unit 10 performs pulse drive or linear drive on the control subject 1 using the digital manipulated variable.

The above-described processing makes it possible to control the control subject 1 to eventually have the target command value.

It should be noted that in FIG. 1 the digital PID controller may have another calculation unit such as a filter in a path between issuing of the target command value and receiving the target command value by the subtracter 3, in a path between the AD converter 11 and the subtracter 3, or in a path between the subtracter 3 and the digital PID control unit 9. However, since such an additional calculation unit is not indispensable in the digital PID controller of the first embodiment, the additional calculation unit is omitted in the digital PID controller. Of course, the omitting does not limit the option of adding the additional calculation unit such as a filter to the digital PID controller.

It should also be note that it has been described in the first embodiment that the AD converter 11 is arranged at a stage preceding the subtracter 3, but the arrangement of the AD converter 11 is not restricted to the above. For example, it is also possible that the subtracter 3 performs its processing in analog, and the AD converter 11 is arranged at a stage following the subtracter 3 in order to convert the analog result to a digital value.

The following describes outputs of the integral dead-band unit 12 and the derivative dead-band unit 13 when an absolute value of the error value is greater than the corresponding set value as well as when the absolute value of the error value is equal to or smaller than the corresponding set value with reference to FIGS. 2A to 2D. FIG. 2A is a graph of first dead-band characteristics of any one of the integral dead-band unit 12 and the derivative dead-band unit 13 (hereinafter, referred to also simply as a “dead-band unit”) in the digital PID controller according to the present invention. FIG. 2B is a graph of second dead-band characteristics of the dead-band unit in the digital PID controller according to the present invention. In each of FIGS. 2A and 2B, a horizontal axis represents an input (namely, an error value) of the integral dead-band unit 12 or the derivative dead-band unit 13, and a vertical axis represents an output of the integral dead-band unit 12 or the derivative dead-band unit 13. In addition, in each of these figures, a broken oblique line represents original unsuppressed input-output proportional characteristics without setting any dead-band width (in other words, linear characteristics), and a thick line represents the first or second dead-band characteristics that are input-output characteristics of the dead-band unit with a bead-band width (in other words, non-linear characteristics).

As shown in FIG. 2, if the dead-band unit has the first dead-band characteristics 14, when an input (error value) of the dead-band unit is within a dead-band width ranging from a positive value of the corresponding set value to a negative value of the corresponding set value (in other words, an absolute value of the input is equal to or smaller than the corresponding set value), the dead-band unit outputs a value of zero. On the other hand, when an input (error value) is in a range except the dead-band width (in other words, an absolute value of the input is greater than the corresponding set value), the dead-band unit outputs a value for which the original unsuppressed input-output characteristics are shifted by a half of the dead-band width along the horizontal axis. The first dead-band characteristics 14 are expressed by the following equations (2).

Y=0 if |X|=<W

Y=k×(X−W) if X>W

Y=k×(X+W) if X<−W (Equations 2)

where Y is an output of the dead-band unit, X is an input (namely, an error value) of the dead-band unit, W is the set value, and k is any desired proportional gain.

As shown in FIG. 2B, it the dead-band unit has the second dead-band characteristics 15, when an input (error value) of the dead-band unit is within a dead-band width ranging from a positive value of the set value to a negative value of the set value (in other words, an absolute value of the input is equal to or smaller than the set value), the dead-band unit outputs a value of zero. On the other hand, when an input (error value) is in a range except the dead-band width (in other words, an absolute value of the input is greater than the set value), the dead-band unit outputs a value for which the original unsuppressed input-output proportional characteristics are not shifted along the horizontal axis. More specifically, in this situation, the dead-band unit outputs a value in proportion to the input of the dead-band width (error value). The second dead-band characteristics 15 are expressed by the following equations (3).

Y=0 if |X|=<W

Y=k×X if X>W

Y=k×X if X<−W (Equations 3)

where Y is an output of the dead-band unit, X is an input (namely, an error value) of the dead-band unit, W is the set value, and k is any desired proportional gain.

As shown in FIGS. 2A and 2B, in both of the first and second dead-band characteristics 14 and 15, when an input is within the dead-band width, the integral dead-band unit 12 and the derivative dead-band unit 13 output values of zero. As far as an error value is within the dead-band width, each of the integral dead-band unit 12 and the derivative dead-band unit 13 converts the undesired error value that results in noise or calculation inaccuracy to be a value of zero. As a result, outputs of the integral calculation unit 5 and the derivative calculation unit 6 are accurate and not fluctuated due to inaccurate error values. In other words, when digital processing causes undesired error values even in a state where target command values are constant and the control proceeds successfully, the digital PID controller of the first embodiment can prevent eventual generation of undesired manipulated variable. Thereby, the integral calculation unit 5 does not accumulate the undesired feedback error values, thereby preventing undesired driving of the control subject 1 when the target command values are constant. In addition, the derivative calculation unit 6 does not amplify the undesired feedback error value generated by the AD converter 11, thereby achieving lower vibration and lower noise of the control subject 1.

In the meanwhile, the first dead-band characteristics 14 and the second dead-band characteristics 15 have clearly different advantages. The difference in advantages is described below with reference also to FIGS. 2C and 2D. FIG. 2C is a graph of temporal changes in input and output of the dead-band unit having the first dead-band characteristics. FIG. 2D is a graph of temporal changes in input and output of the dead-band unit having the second dead-band characteristics. In each of FIGS. 2C and 2D, a horizontal axis represents a time, each of a solid curve line and a broken curve line represents temporal changes in input of the dead-band unit, and a thick line represents temporal changes in output of the dead-band unit.

As shown in FIG. 2C, the advantages of the first dead-band characteristics 14 are that, even if inputs (error values) of the dead-band unit are varied astride a boundary between the dead-band width and a region except the dead-band width (in other words, absolute values of the error values are varied around the set value, being smaller and greater than the set value), outputs of the dead-band unit do not have discontinuity, namely harmonic. On the other hand, the disadvantages of the first dead-band characteristics 14 are that, when inputs (error values) of the dead-band unit are in an overall range except the dead-band width (in other words, absolute values of the error values are greater than the set value), outputs of the dead-band unit are deviated from corresponding desired outputs in the original unsuppressed input-output proportional characteristics (in other words, the outputs have distortion). As a result, the outputs with distortion deteriorate the control characteristics thereby reducing accuracy of the control.

As shown in FIG. 2D, the advantages of the second dead-band characteristics 15 are that, even if inputs (error values) of the dead-band unit are in an overall range except the dead-band width (in other words, absolute values of the error values are greater than the set value), outputs of the dead-band unit are not deviated from corresponding desired outputs in the original unsuppressed input-output proportional characteristics (in other words, the outputs do not have any distortion). On the other hand, the disadvantages of the second dead-band characteristics 15 are that, when inputs (error values) of the dead-band unit are varied astride a boundary between the dead-band width and a region except the dead-band width (in other words, absolute values of the error values are varied around the set value, being smaller and greater than the set value), outputs of the dead-band unit have discontinuity, namely harmonic. As a result, the derivative calculation unit 6 amplifies the harmonics to generate undesired manipulated variables.

In consideration of the above-described advantages and disadvantages, it is preferable for the control characteristics that the integral dead-band unit 12 which does not amplify harmonics has the second dead-band characteristics 15 and the derivative dead-band unit 13 which amplifies harmonics has the first dead-band characteristics 14.

It is also possible that both of the integral dead-band unit 12 and the derivative dead-band unit 13 have the first dead-band characteristics 14, or that both of the integral dead-band unit 12 and the derivative dead-band unit 13 have the second dead-band characteristics 15. It is further possible that the integral dead-band unit 12 has the first dead-band characteristics 14 and the derivative dead-band unit 13 has the second dead-band characteristics 15, although this is not preferable in view of accuracy of the control.

Depending on whether or not the target command values are varied, the advantages and disadvantages of the first and second dead-band characteristics 14 and 15 are analyzed as below.

When target command values are hardly varied, in other words, when input target command values are almost constant, an error value in a range except the dead-band width (in other words, an error value having an absolute value greater than the set value) is unlikely to occur. However, in consideration of the rare situation where such an error value in the range except the dead-band width is actually provided to the dead-band unit and eventually error values are varied astride a boundary between the dead-band width and the range except the dead-band width, it is preferable that the dead-band unit has the first dead-band characteristics 14 so that outputs of the dead-band unit have no discontinuity.

On the other hand, when target command values are not constant but highly varied, error values in the range except the dead-band width are likely to occur. In this situation, it is preferable that the dead-band unit has the second dead-band characteristics 15 so that outputs of the dead-band unit are not deviated from corresponding desired outputs in the original unsuppressed input-output proportional characteristics (in other words, the outputs do not have distortion) when input error values are in the overall range except the dead-band width.

That is, it is preferable that the digital PID controller further has a target value variation determination unit to detect variations in target command values, or has a unit to receive information of existence of variations in target command values from a commander (such as a microcomputer) of the target command values, for example. Then, it is preferable that the digital PID controller further has selectors (in other words, switches) provided to the integral dead-band unit 12 and the derivative dead-band unit 13 in order to select the first dead-band characteristics 14 or the second dead-band characteristics 15, so that the first dead-band characteristics 14 are used when the target command values are constant and the second dead-band characteristics 15 are used when the target command values are not constant.

It should be noted that such a selector may be provided to only one of the integral dead-band unit 12 and the derivative dead-band unit 13. It should also be note that it is also possible to select the first dead-band characteristics 14 or the second dead-band characteristics 15 depending on existence of variations in target command values which is detected by the digital PID controller itself, not depending on information of the existence of the variations which is provided from the commander (such as a microcomputer) of the target command values.

A structure and a function of a means for (i) detecting variations in target command values using the above-mentioned target value variation determination unit or the unit that receives information of existence of the variations from the commander of the target command values, for example, and then (ii) determining a varying state of the target command values are described later in second and third embodiments of the present invention.

It should also be noted that it has been described for the first and second dead-band characteristics that, when an absolute value of an error value provided to the dead-band unit is equal to or smaller than the set value, an output of the dead-band unit is a value of zero. However, the output does not need to be always a value of zero.

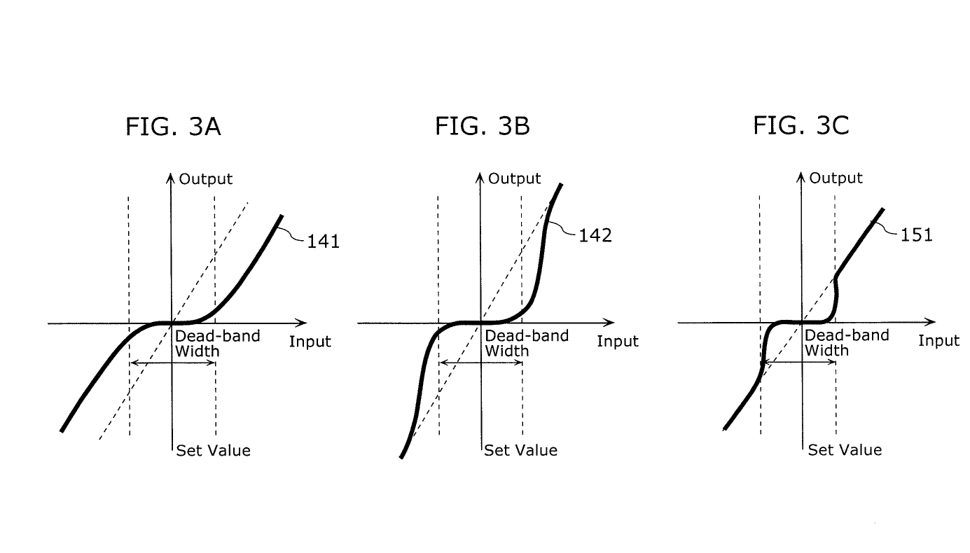

FIGS. 3A, 3B, and 3C are graphs of third, fourth, and fifth dead-band characteristics of the dead-band unit in the digital PID controller according to the present invention, respectively. As shown in each of FIGS. 3A to 3C, if the dead-band unit has the third, fourth, or fifth dead-band characteristics 141, 142, or 151, when an input (error value) of the dead-band unit is within a dead-band width (in other words, an absolute value of the input is equal to or smaller than the corresponding set value), the dead-band unit outputs a value for which original unsuppressed input-output proportional characteristics shown by a broken oblique line is suppressed. However, the output of the dead-band unit is not always zero. Each of the third, fourth, and fifth dead-band characteristics shown in FIGS. 3A to 3C smoothes discontinuity at a boundary between the dead-band width and a region except the dead band width, which is seen in the second dead-band characteristics 15, and also smoothes a rapid change in the dead-band characteristics at the boundary, which is seen in the first dead-band characteristics 14. The smoothness of the discontinuity and the rapid change can prevent that harmonics provided from the derivative dead-band unit 13 are unnecessarily amplified by the derivative calculation unit 6 when input error values are varied astride the boundary. Especially in the fourth dead-band characteristics 142 of FIG. 3B, as an absolute value of an input of the dead-band unit is increased, the fourth dead-band characteristics 142 is gradually approximate to the original unsuppressed input-output proportional characteristics from a point where the absolute value of the input exceeds the set value. Thereby, outputs of the integral calculation unit 5 are not deviated from desired values, in other words, the outputs have no distortion. That is, in the integral calculation, an offset between a well-balanced state and the target state of the control subject 1 is suppressed.

It should be noted that, in the equations (2) and (3), the integral dead-band unit 12 and the derivative dead-band unit 13 may have different first set value W1 and second set value W2, respectively.

(Modification of First Embodiment)

The following describes a digital PID controller according to a modification of the first embodiment of the present invention.

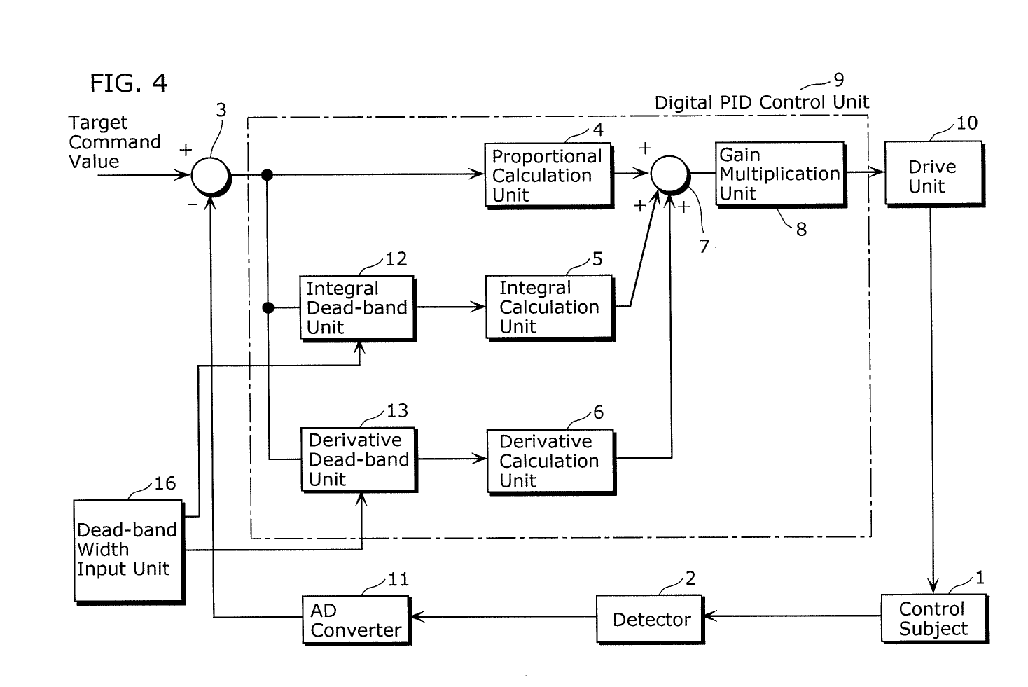

FIG. 4 is a block diagram showing an example of a configuration of a digital PID control system including the digital PID controller according to the modification of the first embodiment of the present invention. In FIG. 4, the digital PID control system includes the control subject 1 and the digital PID controller according to the modification. The digital PID controller controls the control subject 1 to have a target command value, in other words, to be in a target state.

The digital PID controller according to the modification includes the detector 2, the subtracter 3, the digital PID control unit 9, the drive unit 10, the AD converter 11, and a dead-band width input unit 16. The digital PID control unit 9 includes the proportional calculation unit 4, the integral calculation unit 5, the derivative calculation unit 6, the adder 7, the gain multiplication unit 8, the integral dead-band unit 12, and the derivative dead-band unit 13.

In short, the digital PID controller of FIG. 4 differs from the digital PID controller according to the first embodiment of FIG. 1 in that the dead-band width input unit 16 is added. Here, the same reference numerals of FIG. 1 are assigned to the identical units of FIG. 4 having the identical functions, so that the identical units are not explained again below. The following describes the difference only.

The dead-band width input unit 16 is connected to the integral dead-band unit 12 and the derivative dead-band unit 13. The dead-band width input unit 16 statically or dynamically adjusts the dead-band widths of the dead-band characteristics of the integral dead-band unit 12 and the derivative dead-band unit 13. In more detail, the dead-band width input unit 16 adjusts the set value to adjust the dead-band width. Thereby, the digital PID controller according to the modification can perform control using more optimum dead-band widths, by adjusting the dead-band widths according to characteristics of the digital PID control system, changes in control conditions, or the like. For example, especially under control conditions where noises and calculation errors are likely to occur, the dead-band width is increased according to a size of an error value. On the other hand, under control conditions where noise and calculation errors are unlikely to occur, the dead-band width is decreased according to a size of an error value. For another optimization, when a degree of variations in target command values is small, in other words, when input target command values are constant, the dead-band width is increased. On the other hand, when a degree of variations in target command values is large, in other words, when input target command values are varied, the dead-band width is decreased. Here, the expression of “when a degree of variations in target command values is small” means, for example, when a derivative value of the target command values in a predetermined time period is smaller than a predetermined threshold value or when an amount of the variations of the target command values sampled in a predetermined time period is smaller than a predetermined threshold value. For still another optimization, when lower noise and lower vibration are desired, the dead-band width is increased. On the other hand, when noise and vibration do not need to be lowered, the dead-band width is decreased.

It should be noted that the dead-band width input unit 16 may set different dead-band widths for the integral dead-band unit 12 and the derivative dead-band unit 13, respectively, or may set the same dead-band width for both of the dead-band units.

As described above, each of the digital PID controller according to the first embodiment of the present invention and the digital PID controller according to the modification of the first embodiment has at least one of (i) the integral dead-band unit 12 at the stage preceding the integral calculation unit 5 and (ii) the derivative dead-band unit 13 at the stage preceding the derivative calculation unit 6. Thereby, even if undesired error values are generated in a state where control proceeds successfully, it is possible to prevent undesired manipulated variables. In addition, since a value suppressed from the error value for the integral calculation and a value suppressed from the error value for the derivative calculation are decided by different suppression units, it is possible to optimize each value suppressed from the error value depending on the corresponding calculation. As a result, low vibration and low noise can be achieved.

It should be noted that it has been described in the first embodiment and its modification that the digital PID control unit 9 has both of the integral dead-band unit 12 and the derivative dead-band unit 13, but the digital PID control unit 9 may have at least one of the integral dead-band unit 12 and the derivative dead-band unit 13.

### Second Embodiment

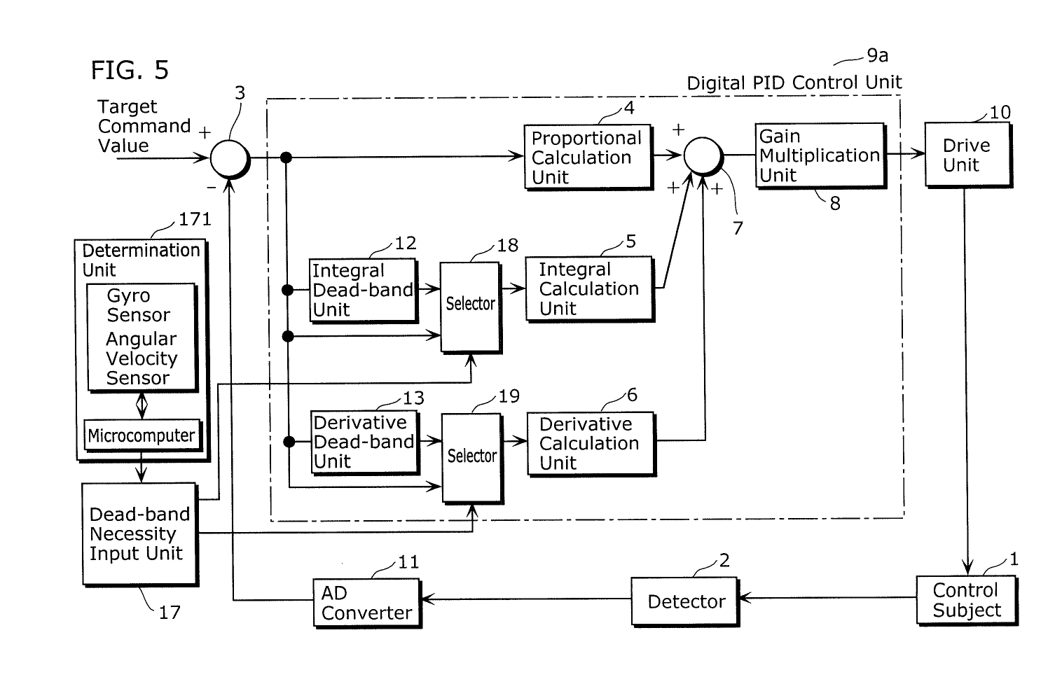

The following describes a digital PID controller according to a second embodiment of the present invention. The digital PID controller of the second embodiment differs from the digital PID controller of the first embodiment in that a dead-band necessity input unit is added to determine whether or not to use each of the integral dead-band unit 12 and the derivative dead-band unit 13. The difference from the first embodiment is described below with reference to FIG. 5. Here, the same reference numerals of FIG. 1 are assigned to the identical units of FIG. 5 having the identical functions, so that the identical units are not explained again below.

FIG. 5 is a block diagram showing an example of a configuration of a digital PID control system including the digital PID controller according to the second embodiment of the present invention. The digital PID control system of FIG. 5 includes the control subject 1 and the digital PID controller according to the second embodiment. The digital PID controller controls the control subject 1 to have a target command value, in other words, to be in a target state. The digital PID controller includes the detector 2, the subtracter 3, a digital PID control unit 9a, the drive unit 10, the AD converter 11, a dead-band necessity input unit 17, and a determination unit 171.

The digital PID control unit 9a includes the proportional calculation unit 4, the integral calculation unit 5, the derivative calculation unit 6, the adder 7, the gain multiplication unit 8, the integral dead-band unit 12, the derivative dead-band unit 13, and a selector 18, and a selector 19. In short, the structure of the digital PID controller according to the second embodiment differs from the structure of the digital PID controller according to the first embodiment in that the dead-band necessity input unit 17 and the determination unit 171 are further added and that the digital PID control unit further includes the selector 18 and the selector 19.

The digital PID controller according to the second embodiment basically has the same object and advantages as those of the digital PID controller according to the first embodiment. The digital PID controller according to the second embodiment has at least one of the integral dead-band unit 12 at the stage preceding the integral calculation unit 5 and the derivative dead-band unit 13 at the stage preceding the derivative calculation unit 6. With the structure, when digital processing causes undesired error values even in a state where target command values are constant and the control proceeds successfully, the digital PID controller of the second embodiment can prevent eventual generation of undesired manipulated variable. Thereby, as the digital PID controller of the first embodiment can, the digital PID controller of the second embodiment can also achieve lower vibration and lower noise of the control subject 1, thereby improving accuracy of the control of the digital PID controller.

The dead-band necessity input unit 17 instructs each of the selectors 18 and 19 to select between an error value calculated by the subtracter 3 and an output of the corresponding dead-band unit, based on information provided from the determination unit 171.

The determination unit 171 detects variations in target command values (namely, values of target states of the control subject 1) using a gyro sensor or an angular velocity sensor, and analyzes the resulting detected value by a microcomputer or the like to generate a degree of the variations. Based on the degree of the variations, the determination unit 171 determines whether or not each of the integral dead-band unit 12 and the derivative dead-band unit 13 is to be used in the processing of the digital PID control unit 9a, and then provides the determination result as selection instruction and the degree of the variations to the dead-band necessity input unit 17.

The selector 18 has a function of an integrate selector that selects an input of the integral calculation unit 5. According to the instruction from the dead-band necessity input unit 17, the selector 18 selects between an output of the integral dead-band unit 12 and an error value provided from the subtracter 3, and then provides the selected one to the integral calculation unit 5.

The selector 19 has a function of a derivative selector that selects an input of the derivative calculation unit 6. According to the instruction from the dead-band necessity input unit 17, the selector 19 selects between an output of the derivative dead-band unit 13 and an error value provided from the subtracter 3, and then provides the selected one to the derivative dead-band unit 13.

As described in the first embodiment, while the first dead-band characteristics 14 and the second dead-band characteristics 15 shown in FIGS. 2A to 2D have advantages of suppressing influence of undesired error values when the error values are within the dead-band width, they also have disadvantages when error values are varied astride the dead-band width or in a range except the dead-band width. Therefore, the use of the integral dead-band unit 12 and the derivative dead-band unit 13 does not always optimize the control characteristics of the digital PID controller.

In order to prevent the disadvantages of the dead-band units having undesired influence of distortion, namely discontinuity of outputs of the dead-band units, the digital PID controller according to the second embodiment can select whether or not to use each of the integral dead-band unit 12 and the derivative dead-band unit 13, thereby achieving more optimized control characteristics to improve the control accuracy more. In more detail, neither the integral dead-band unit 12 or the derivative dead-band unit 13 are used, (i) when inputs (error values) of the dead-band unit are varied astride the dead-band width or the inputs are in a range except the dead-band width due to discontinuity of the target command values, (ii) when lower noise and lower vibration are not desired, (iii) when a noise source that is not the digital PID controller is not operated, or other situations.

It should be noted that it has been described in the second embodiment that the selection of (in other words, switching) whether or not to use each dead-band unit is performed by a corresponding selector that selects between a path with the dead-band unit and a path without the dead-band unit, but the selection may be performed by another function that sets the dead-band width in the dead-band unit to zero.

It should also be note that the selection can be performed for only one of the integral dead-band unit 12 and the derivative dead-band unit 13.

It should also be note that the dead-band necessity input unit 17 may be a serial interface or the like that passes instruction given from a microcomputer or a user of the digital PID controller to the selectors.

It should also be note that the determination unit 171 may not have the gyro sensor, the angular velocity sensor, and the microcomputer, but may be a user of the digital PID controller who performs the above-described determination.

It should also be note that the digital PID controller according to the second embodiment may include the dead-band width input unit 16 that has been described in the modification of the first embodiment to statically or dynamically adjust the dead-band widths of the dead-band units. With the dead-band width input unit 16, the digital PID controller according to the second embodiment can perform control using more optimum dead-band width according to characteristics of the digital PID control system, changes in control conditions, or the like.

As described above, the digital PID controller according to the second embodiment has at least one of the integral dead-band unit 12 at the stage preceding the integral calculation unit 5 and the derivative dead-band unit 13 at the stage preceding the derivative calculation unit 6. With the structure, when digital processing causes undesired error values even in a state where target command values are constant and the control proceeds successfully, the digital PID controller of the second embodiment can prevent eventual generation of undesired manipulated variable. Thereby, the digital PID controller of the second embodiment can achieve lower vibration and lower noise of the control subject 1, thereby improving accuracy of the control of the digital PID controller. In addition, according to instruction from the dead-band necessity input unit 17, the selector provided to the corresponding dead-band unit selects whether or not to use the dead-band unit. With the structure, the digital PID controller according to the second embodiment can prevent the disadvantages of the dead-band unit, namely influence of distortion and discontinuity of outputs of the dead-band unit, thereby achieving more optimized control characteristics to improve the control accuracy more.

### Third Embodiment

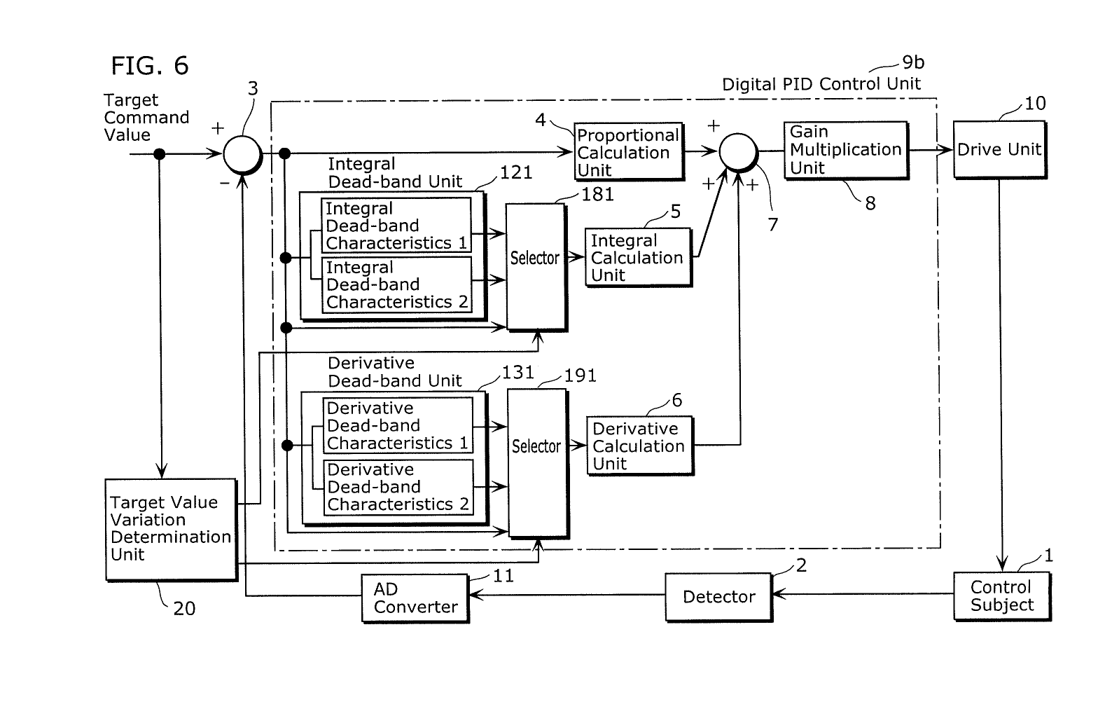

The following describes a digital PID controller according to a third embodiment of the present invention with reference to FIG. 6. The digital PID controller of the third embodiment differs from the digital PID controller of the second embodiment in that a target value variation determination unit is further included to (i) detect a degree of variations in target command values for a control subject, and (ii) according to the degree of the variations, (ii-1) determine whether or not each of the dead-band unit is to be selected to be used and (ii-2) which dead-band characteristics is to be selected for the to-be-used dead-band unit. The below description is given mainly for the difference from the second embodiment. Here, the same reference numerals of FIG. 5 are assigned to the identical units of FIG. 6 having the identical functions, so that the identical units are not explained again below

FIG. 6 is a block diagram showing an example of a configuration of a digital PID control system including the digital PID controller according to the third embodiment of the present invention. The digital PID control system of FIG. 6 includes the control subject 1 and the digital PID controller according to the third embodiment. The digital PID controller controls the control subject 1 to have a target command value, in other words, to be in a target state. The digital PID controller includes the detector 2, the subtracter 3, a digital PID control unit 9b, the drive unit 10, the AD converter 11, and a target value variation determination unit 20.

The digital PID control unit 9b includes the proportional calculation unit 4, the integral calculation unit 5, the derivative calculation unit 6, the adder 7, the gain multiplication unit 8, an integral dead-band unit 121, a derivative dead-band unit 131, a selector 181, and a selector 191. The structure of the digital PID controller according to the third embodiment differs from the structure of the digital PID controller according to the second embodiment in that the determination unit 171 and the dead-band necessity input unit 17 are eliminated, that the target value variation determination unit 20 is added, that the integral dead-band unit 12 and the derivative dead-band unit 13 are replaced by the integral dead-band unit 121 and the derivative dead-band unit 131, and that the selectors 18 and 19 are replaced by the selectors 181 and 191.

The integral dead-band unit 121 has integral dead-band characteristics 1 and integral dead-band characteristics 2 which are different dead-band characteristics. In this example, these dead-band characteristics are the first dead-band characteristics 14 and the second dead-band characteristics 15 which have been already described. According to selection of the selector 181, the integral dead-band unit 121 changes the dead-band characteristics to be used.

The derivative dead-band unit 131 has derivative dead-band characteristics 1 and derivative dead-band characteristics 2 which are different dead-band characteristics. In this example, these dead-band characteristics are the first dead-band characteristics 14 and the second dead-band characteristics 15 which have been already described. According to selection of the selector 191, the derivative dead-band unit 131 changes the dead-band characteristics to be used.

It should be noted that the dead-band characteristics of the integral dead-band unit 121 and the derivative dead-band unit 131 are not limited to the above-described first and second dead-band characteristics 14 and 15, but when an input of the dead-band unit is within the dead-band width, they may be characteristics that are generated by suppressing the original input-output proportional characteristics, such as the third, fourth, and fifth dead-band characteristics 141, 142, and 151 as shown in FIGS. 3A to 3C.

The selector 181 has a function of an integral a selector that selects an input of the integral calculation unit 5. According to instruction from the target value variation determination unit 20, the selector 181 selects between an output of the integral dead-band unit 121 and an error value provided from the subtracter 3. When the output of the integral dead-band unit 121 is selected, the selector 181 further selects between the integral dead-band characteristics 1 and integral dead-band characteristics 2. Eventually, the selector 181 provides the finally selected one to the integral calculation unit 5.

The selector 191 has a function of a derivative selector that selects an input of the derivative calculation unit 6. According to instruction from the target value variation determination unit 20, the selector 191 selects between an output of the derivative dead-band unit 131 and an error value provided from the subtracter 3. When the output of the derivative dead-band unit 131 is selected, the selector 191 further selects between the derivative dead-band characteristics 1 and derivative dead-band characteristics 2. Eventually, the selector 191 provides the finally selected one to the derivative calculation unit 6.

The target value variation determination unit 20 receives target command values that are digital values of the target states of the control subject 1, and detects a degree of variations in the target command values. Then, according to the degree of the variations in the target command values, the target value variation determination unit 20 determines (i) whether or not each dead-band unit is to be selected to be used and (ii) which dead-band characteristics is to be selected for the to-be-used dead-band unit, and instructs the determination results to the dead-band unit. In more detail, the target value variation determination unit 20 makes the above determination, for example, by comparing a derivative value of the target command values to a predetermined threshold value or comparing an amount of the variations of the target command values detected by each sampling to a predetermined threshold value.

The digital PID controller according to the third embodiment basically has the same object and advantages as those of the digital PID controller according to the second embodiment. The digital PID controller according to the third embodiment has at least one of the integral dead-band unit 121 at the stage preceding the integral calculation unit 5 and the derivative dead-band unit 131 at the stage preceding the derivative calculation unit 6. With the structure, when digital processing causes undesired error values even in a state where target command values are constant and the control proceeds successfully, the digital PID controller of the third embodiment can prevent eventual generation of undesired manipulated variable. Thereby, as the digital PID controller of the first and second embodiments can, the digital PID controller of the third embodiment can also achieve lower vibration and lower noise of the control subject 1, thereby improving accuracy of the control of the digital PID controller. In addition, the digital PID controller according to the third embodiment has the selector 181 that selects whether or not to use the integral dead-band unit 121 and the selector 191 that selects whether or not to use the derivative dead-band unit 131. Thereby, as the digital PID controller of the second embodiment can, the digital PID controller of the third embodiment can achieve more optimized control characteristics to improve the control accuracy more.

Furthermore, the digital PID controller according to the third embodiment includes the target value variation determination unit 20 that detects variations in target command values, which makes it possible to determine whether or not each of the dead-band unit is to be selected to be used and which dead-band characteristics is to be selected for the to-be-used dead-band unit. As described above, while the first dead-band characteristics 14 and the second dead-band characteristics 15 have advantages of suppressing influence of undesired error values when the error values are within the dead-band width, they also have disadvantages when the error values are varied astride the dead-band width or in a range except the dead-band width. Therefore, the use of the integral dead-band unit 12 and the derivative dead-band unit 13 does not always optimize the control of the digital PID controller.

In order to prevent the disadvantages, in the digital PID controller according to the third embodiment, the target value variation determination unit 20 performs the following processing. Firstly, the target value variation determination unit 20 detects a degree of variations in target command values. Then, when the target command values are hardly varied (in other words, when the input target command values are constant because in these situations an error value in a range except the dead-band width is unlikely to occur, namely, when the detected degree of the variations in the target command values is small), the target value variation determination unit 20 determines that the integral dead-band unit 121 and the derivative dead-band unit 131 are to be used to use the first dead-band characteristics 14 or the second dead-band characteristics 15. On the other hand, when the target command values are not constant but highly varied (in other words, when the detected degree of the variations in the target command values is large), the target value variation determination unit 20 determines that none of the integral dead-band unit 121 and the derivative dead-band unit 131 are to be used but the error values are to be selected by the selector. This is because avoidance of use of the integral dead-band unit 121 and the derivative dead-band unit 131 can eliminate the disadvantages of these dead-band units, such as bad influence of distortion and discontinuity of outputs of the dead-band units, thereby achieving more optimized control characteristics to improve the control accuracy more. It should be noted that it has been described in the third embodiment that the selection whether or not to use the dead-band unit is performed by a corresponding selector that selects between a path with the dead-band unit and a path without the dead-band unit, but the selection may be performed by another function that sets the dead-band width in the dead-band unit to zero.

It should also be note that the above-described selection is not limited to the above and the selection can be performed for one of the integral dead-band unit 121 and the derivative dead-band unit 131.

It should also be note that the target value variation determination unit 20 may be implemented as a circuit that compares a derivation of a target command value to a predetermined threshold value, or a circuit that compares an amount of variations in each sampling set of target command values to a predetermined threshold value, for example.

The above-described determination made by the target value variation determination unit can be made also by the dead-band necessity input unit 17 included in the digital PID controller according to the second embodiment. However, the structure including the target value variation determination unit 20 has advantages that instruction from a microcomputer or a user of the digital PID controller is no longer necessary to make the determination.

It should also be note that the digital PID controller according to the third embodiment may include the dead-band width input unit 16 that has been described in the modification of the first embodiment to statically or dynamically adjust the dead-band widths of the dead-band units. With the dead-band width input unit 16, the digital PID controller according to the third embodiment can perform control using more optimum dead-band width according to characteristics of the digital PID control system, changes in control conditions, or the like.

As described above, the digital PID controller according to the third embodiment has at least one of the integral dead-band unit 121 at the stage preceding the integral calculation unit 5 and the derivative dead-band unit 131 at the stage preceding the derivative calculation unit 6. With the structure, when digital processing causes undesired error values even in a state where target command values are constant and the control proceeds successfully, the digital PID controller of the first embodiment can prevent eventual generation of undesired manipulated variable. Thereby, the digital PID controller of the third embodiment can achieve lower vibration and lower noise of the control subject 1, thereby improving accuracy of the control of the digital PID controller. In addition, including the selector 181 that selects whether or not to use the integral dead-band unit 121 and which dead-band characteristics is to be used, the selector 191 that selects whether or not to use the derivative dead-band unit 131 and which dead-band characteristics is to be used, and the target value variation determination unit 20 that determines whether or not each dead-band unit is to be selected to be used and which dead-band characteristics is to be selected for the to-be-used dead-band unit, the digital PID controller according to the third embodiment can prevent the disadvantages of the dead-band units, namely, bad influence of distortion and discontinuity of outputs of the dead-band units, without increasing loads on the microcomputer or the user of the digital PID controller. As a result, the digital PID controller according to the third embodiment can achieve more optimized control characteristics to improve the control accuracy more.

It should be noted that it has been described in the third embodiment that each of the selectors 181 and 191 makes a selection of whether or not to use the corresponding dead-band unit, and a further selection, if the corresponding dead-band unit is to be used, of which characteristics is to be used, but each of the selectors 181 and 191 may perform only one of the selections.

### Fourth Embodiment

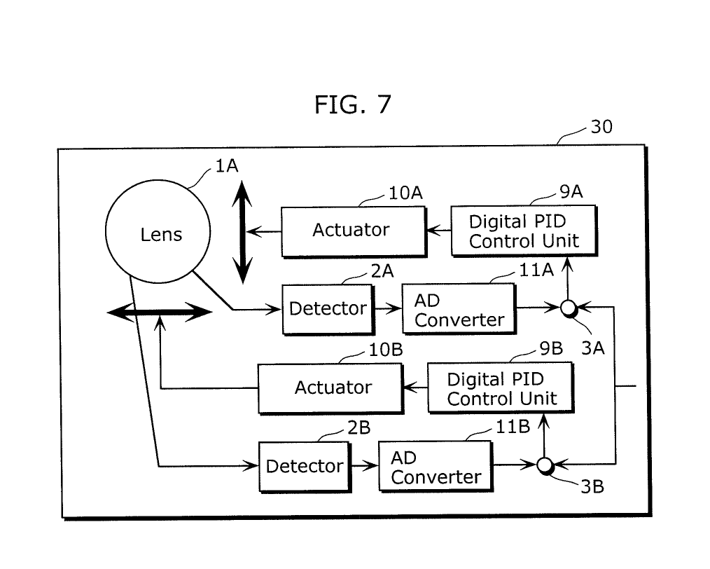

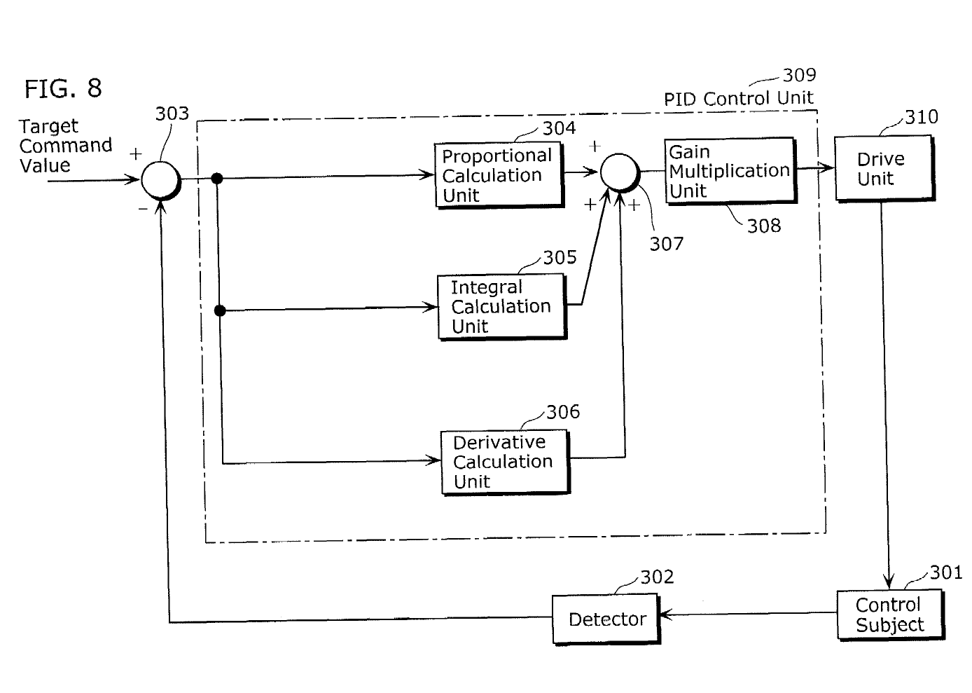

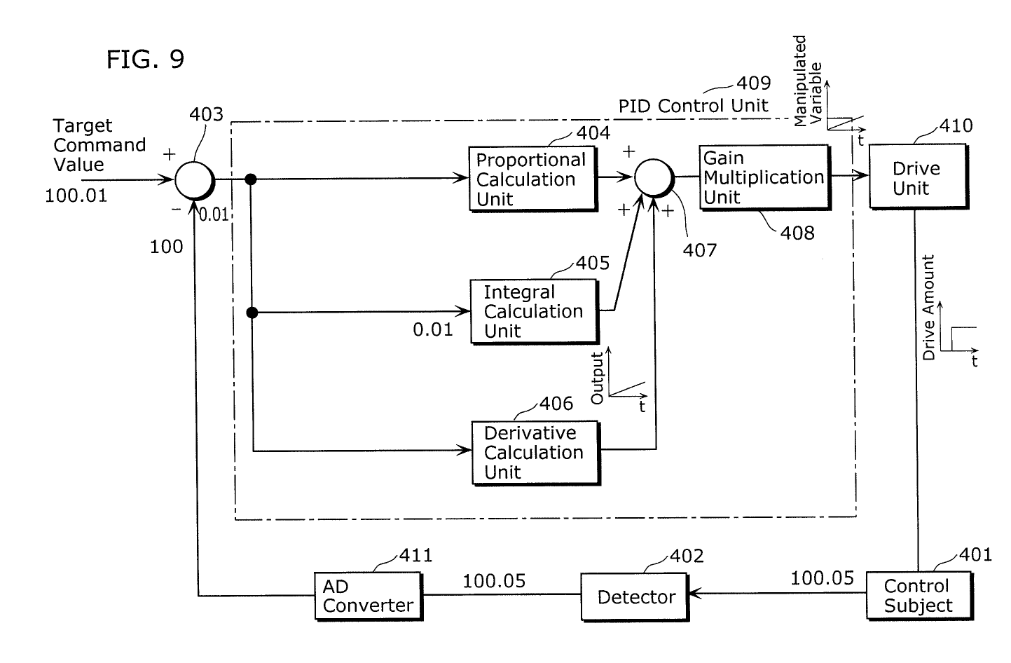

FIG. 7 is a functional block diagram of a DSC in which the digital PID controller according to a fourth embodiment of the present invention is embedded. The DSC 30 of FIG. 7 includes a lens 1A and the digital PID controller according to the fourth embodiment. The digital PID controller controls the lens 1A to have a target value (namely, target command value), in other words, to be in a target state. The digital PID controller embedded in the DSC 30 includes detectors 2A and 2B, subtracters 3A and 3B, and digital PID control units 9A and 9B, and actuators 10A and 10B, and AD converters 11A and 11B. Here, each of the detectors 2A and 2B corresponds to the detector 2 in the first to third embodiments, each of the subtracters 3A and 3B corresponds to the subtracter 3 in the first to third embodiments, and each of the digital PID control units 9A and 9B corresponds to the digital PID control unit 9, 9a, or 9b in the first to third embodiments, each of the actuators 10A and 10B corresponds to the drive unit 10 in the first to third embodiments, and each of the AD converters 11A and 11B corresponds to the AD converters 11 in the first to third embodiments. In addition, the lens 1A corresponds to the control subject 1 in the first to third embodiments. A position of the lens 1A in the DSC 30 of FIG. 7 is controlled by two different directions. A current position of the lens 1A is determined independently by the detectors 2A and 2B, and the subtracters 3A and 3B calculate respective differences between the target value and the current positions determined by the detectors 2A and 2B, respectively. The subtracters 3A and 3B provide the calculated differences as error values to the digital PID control units 9A and 9B, respectively. Each of the digital PID control units 9A and 9B receives the corresponding error value from the corresponding subtracter 3A or 3B, and digitally performs PID calculations in the same manner as described previously to generate a corresponding manipulated variable. The actuators 10A and 10B, each of which serves as the above-described drive unit, independently drive the lens 1A according to the manipulated variables provided from the digital PID control units 9A and 9B, respectively.

The above-described processing makes it possible to control the lens 1A to eventually have the target value.

Here, each of the digital PID control units 9A and 9B may include at least one of the integral dead-band unit 12 or 121 and the derivative dead-band unit 13 or 131 which have been described in the first to third embodiments. With the structure, when digital processing causes undesired error values even in a state where target command values are constant and the control proceeds successfully, the DSC 30 can prevent eventual generation of undesired manipulated variables. Thereby, the DSC 30 can achieve lower vibration and lower noise caused by the lens 1A.

Although only the digital PID controllers according to some exemplary embodiments and modifications of the present invention have been described in detail above, those skilled in the art will be readily appreciate that many modifications are possible in the exemplary embodiments without materially departing from the novel teachings and advantages of the present invention. Accordingly, all such modifications and various devices including the above digital PID controllers are intended to be included within the scope of the present invention.

### INDUSTRIAL APPLICABILITY

The present invention is useful as a digital PID controller that performs position control or the like. More particularly, the present invention is useful as a digital PID controller that suppresses undesired manipulated variables used to control a control subject thereby achieving lower vibration and lower noises of the control subject.

What is claimed is:

1. A digital PID controller that controls a control subject to be in a target state, said digital PID controller comprising:
a detector that detects a current state of the control subject to generate analog data of the current state;
an AD converter that converts the analog data to a digital value of the current state; and
a digital PID control unit configured to (i) receive an error value that is a difference between the digital value and a digital target value of the target state, and (ii) digitally perform at least one of integral calculation and derivative calculation depending on the error value to generate a digital manipulated variable to be used to control the control subject,
wherein said digital PID control unit includes
at least one of: a first suppression unit configured to suppress the error value to be outputted when an absolute value of the error value is equal to or smaller than a first set value; and a second suppression unit configured to suppress the error value to be outputted when the absolute value of the error value is equal to or smaller than a second set value, and
said digital PID control unit is configured to digitally perform at least one of the integral calculation on the output of said first suppression unit and the derivative calculation on the output of said second suppression unit, in order to generate the digital manipulated variable.

2. The digital PID controller according to claim 1,
wherein said digital PID control unit
is configured to (i) receive the error value and (ii) digitally perform at least the integral calculation and the derivative calculation depending on the error value to generate the digital manipulated variable, and
includes said first suppression unit and said second suppression unit, and
wherein said digital PID control unit is configured to digitally perform: the integral calculation on the output of said first suppression unit; and the derivative calculation on the output of said second suppression unit, in order to generate the digital manipulated variable

3. The digital PID controller according to claim 1,
wherein said first suppression unit is configured to output a value of zero when the absolute value of the error value is equal to or smaller than the first set value, and said second suppression unit is configured to output a value of zero when the absolute value of the error value is equal to or smaller than the second set value.

4. The digital PID controller according to claim 3,
wherein said first suppression unit is further configured to
output a first integrate suppression value in proportion to a value that is calculated by subtracting the error value with the first set value, when the absolute value of the error value is greater than the first set value and the error value is positive, and
output a second integrate suppression value in proportion to a value that is calculated by adding the error value with the first set value, when the absolute value of the error value is greater than the first set value and the error value is negative,
said second suppression unit is further configured to
output a first derivative suppression value in proportion to a value that is calculated by subtracting the error value with the second set value, when the absolute value of the error value is greater than the second set value and the error value is positive, and
output a second derivative suppression value in proportion to a value that is calculated by adding the error value with the second set value, when the absolute value of the error value is greater than the second set value and the error value is negative, and
said digital PID control unit is configured to digitally perform at least one of: the integral calculation on the first integral suppression value or the second integral suppression value; and the derivative calculation on the first derivative suppression value or the second derivative suppression value.

5. The digital PID controller according to claim 4, further comprising
at least one of: an integral selector which selects between the output of said first suppression unit and the error value; and a derivative selector which selects between the output of said second suppression unit and the error value, and
said digital PID control unit is further configured to digitally perform at least one of: the integral calculation on one of the output and the error value selected by said integral selector; and the derivative calculation on one of the output and the error value selected by said derivative selector, in order to generate the digital manipulated variable.

6. The digital PID controller according to claim 5, further comprising
a target value variation determination unit configured to (i) detect a degree of variations in the digital target values, and (ii) perform at least one of: (ii-1) instruction to said integral selector to (ii-1-1) select the output of said first suppression unit when the degree of the variations is small and (ii-1-2) select the error value when the degree of the variations is large; and (ii-2) instruction to said derivative selector to (ii-2-1) select the output of said second suppression unit when the degree of the variations is small and (ii-2-2) select the error value when the degree of the variations is large.

7. The digital PID controller according to claim 1,
wherein said first suppression unit is further configured to output an integrate suppression value in proportion to the error value, when the absolute value of the error value is greater than the first set value,
said second suppression unit is further configured to output a derivative suppression value in proportion to the error value, when the absolute value of the error value is greater than the second set value, and
said digital PID control unit is configured to digitally perform at least one of: the integral calculation on the integral suppression value; and the derivative calculation on the derivative suppression value.

8. The digital PID controller according to claim 7,
wherein said first suppression unit is configured to output a value of zero when the absolute value of the error value is equal to or smaller than the first set value, and said second suppression unit is configured to output a value of zero when the absolute value of the error value is equal to or smaller than the second set value.

9. The digital PID controller according to claim 1,
wherein said first suppression unit is further configured to
output a first integrate suppression value in proportion to a value that is calculated by subtracting the error value with the first set value, when a degree of variations in the digital target values is small, the absolute value of the error value is greater than the first set value, and the error value is positive,
output a second integrate suppression value in proportion to a value that is calculated by adding the error value with the first set value, when the degree of the variations in the digital target values is small, the absolute value of the error value is greater than the first set value, and the error value is negative, and
output a third integrate suppression value in proportion to the error value, when the degree of the variations in the digital target values is large and the absolute value of the error value is greater than the first set value,
said second suppression unit is further configured to
output a first derivative suppression value in proportion to a value that is calculated by subtracting the error value with the second set value, when the degree of the variations in the digital target values is small, the absolute value of the error value is greater than the second set value, and the error value is positive,
output a second derivative suppression value in proportion to a value that is calculated by adding the error value with the second set value, when the degree of the variations in the digital target values is small, the absolute value of the error value is greater than the second set value, and the error value is negative, and
output a third derivative suppression value in proportion to the error value, when the degree of the variations in the digital target values is large, and the absolute value of the error value is greater than the second set value, and
said digital PID control unit is configured to digitally perform at least one of: the integral calculation on the first integral suppression value, the second integral suppression value, or the third integral suppression value; and the derivative calculation on the first derivative suppression value, the second derivative suppression value, or the third derivative suppression value.

10. The digital PID controller according to claim 9, further comprising
at least one of: an integral selector which selects between the output of said first suppression unit and the error value; and a derivative selector which selects between the output of said second suppression unit and the error value,
wherein said digital PID control unit is further configured to digitally perform at least one of: the integral calculation on one of the output and the error value selected by said integral selector; and the derivative calculation on one of the output and the error value selected by said derivative selector, in order to generate the digital manipulated variable.

11. The digital PID controller according to claim 10,
wherein said first suppression unit is configured to output a value of zero when the absolute value of the error value is equal to or smaller than the first set value, and said second suppression unit is configured to output a value of zero when the absolute value of the error value is equal to or smaller than the second set value.

12. The digital PID controller according to claim 1,
said first suppression unit is further configured to
output an integrate suppression value in proportion to the error value, when the absolute value of the error value is greater than the first set value,
said second suppression unit is further configured to
output a first derivative suppression value in proportion to a value that is calculated by subtracting the error value with the second set value, when the absolute value of the error value is greater than the second set value and the error value is positive, and
output a second derivative suppression value in proportion to a value that is calculated by adding the error value with the second set value, when the absolute value of the error value is greater than the second set value and the error value is negative, and
said digital PID control unit is configured to digitally perform at least one of: the integral calculation on the integral suppression value; and the derivative calculation on the first derivative suppression value or the second derivative suppression value.

13. The digital PID controller according to claim 12, further comprising
at least one of: an integral selector which selects between the output of said first suppression unit and the error value; and a derivative selector which selects between the output of said second suppression unit and the error value,
wherein said digital PID control unit is further configured to digitally perform at least one of: the integral calculation on one of the output and the error value selected by said integral selector; and the derivative calculation on one of the output and the error value selected by said derivative selector, in order to generate the digital manipulated variable.

14. The digital PID controller according to claim 13, further comprising
a target value variation determination unit configured to (i) detect a degree of variations in the digital target values, and (ii) performs at least one of: (ii-1) instruction to said integral selector to (ii-1-1) select the output of said first suppression unit when the degree of the variations is small and (ii-1-2) select the error value when the degree of the variations is large; and (ii-2) instruction to said derivative selector to (ii-2-1) select the output of said second suppression unit when the degree of the variations is small and (ii-2-2) select the error value when the degree of the variations is large.

15. The digital PID controller according to claim 14,
wherein said first suppression unit is configured to output a value of zero when the absolute value of the error value is equal to or smaller than the first set value, and said second suppression unit is configured to output a value of zero when the absolute value of the error value is equal to or smaller than the second set value.

16. The digital PID controller according to claim 1, further comprising
at least one of: an integral selector which selects between the output of said first suppression unit and the error value; and a derivative selector which selects between the output of said second suppression unit and the error value,
wherein said digital PID control unit is further configured to digitally perform at least one of: the integral calculation on one of the output and the error value selected by said integral selector; and the derivative calculation on one of the output and the error value selected by said derivative selector, in order to generate the digital manipulated variable.

17. The digital PID controller according to claim 16, further comprising
a target value variation determination unit configured to (i) detect a degree of variations in the digital target values, and (ii) performs at least one of: (ii-1) instruction to said integral selector to (ii-1-1) select the output of said first suppression unit when the degree of the variations is small and (ii-1-2) select the error value when the degree of the variations is large; and (ii-2) instruction to said derivative selector to (ii-2-1) select the output of said second suppression unit when the degree of the variations is small and (ii-2-2) select the error value when the degree of the variations is large.

18. The digital PID controller according to claim 1, further comprising
a set value adjustment unit configured to adjust at least one of the first set value and the second set value, according to a degree of variations in the digital target values or the error value.

19. The digital PID controller according to claim 1, further comprising
an actuator that drives the control subject according to the digital manipulated variable generated by said digital PID control unit.

20. A digital PID control method used in a digital PID controller that controls a control subject to be in a target state, by receiving a digital error value that is a difference between a value of a current state of the control subject and a value of the target state of the control subject, performing at least one of integral calculation and derivative calculation depending on the received digital error value in order to generate a digital manipulated variable to be used to control the control subject, said digital PID control method comprising
generating the digital manipulated variable by digitally performing at least one of: the integral calculation on an input that is a first suppression value generated by suppressing the digital error value when an absolute value of the digital error value is equal to or smaller than a first set value; and the derivative calculation on an input that is a second suppression value generated by suppressing the digital error value when the absolute value of the digital error value is equal to or smaller than a second set value.
